(19) United States
(12) Patent Application Publication
(10) Pub. No.: US 2023/0083794 A1
(43) Pub. Date: Mar. 16, 2023

(54) IRON

(71) Applicant: Panasonic Intellectual Property Management Co., Ltd., Osaka (JP)

(72) Inventors: Wataru SANEMATSU, Kyoto (JP); Atsushi TSUJI, Osaka (JP); Yumi HANATO, Shiga (JP); Mahito NUNOMURA, Kyoto (JP)

(21) Appl. No.: 17/792,579

(22) PCT Filed: Feb. 16, 2021
(86) PCT No.: PCT/JP2021/005594

§ 371 Date: Jul. 13, 2022

(30) Foreign Application Priority Data
Feb. 21, 2020 (JP) 2020-028771

(51) Int. Cl. D06F 75/26; D06F 75/24; H05B 1/02; H05B 3/00

(52) U.S. Cl. CPC D06F 75/26; D06F 75/246; H05B 1/0255; H05B 3/0071; G02B 5/208

(57) ABSTRACT

An iron according to the present disclosure includes a light emitter that emits light, a base surface that transmits the light, a detector that detects a temperature of the base surface, and a controller that controls an output of the light emitter in accordance with the temperature of the base surface detected by the detector. Variations in the temperature of the base surface are less than a temperature of clothes. According to the iron, since the output of the light emitter can be controlled in accordance with the temperature of the base surface, heat can be suitably transmitted to the clothes.

### TECHNICAL FIELD

The present disclosure relates to an iron.

### BACKGROUND ART

An iron capable of ironing clothes by using a light emitter as a heat source has been known. PTL 1 discloses a configuration of an iron that adjusts a light emission amount of a light emitter in accordance with a color or a temperature of clothes detected by a temperature sensor.

### CITATION LIST

### Patent Literature

PTL 1: Unexamined Japanese Patent Publication No. H4-5998

### SUMMARY OF THE INVENTION

In a method for controlling an output of the light emitter by identifying the color of the clothes, there are the following problems when the clothes include a plurality of color tones such as a pattern. It is difficult to control a plurality of colors of the light emitter simultaneously after grasping the plurality of colors of the entire clothes. In control based on a surface temperature of the clothes, the iron moves at an unequal speed, a target portion of fabric changes each time, and variations in a temperature distribution of the fabric inevitably occur. Thus, it is difficult to control the light emitter for each portion after grasping the variations in the temperature distribution. As described above, in the iron of the related art, the control of the light emitter is not appropriate, and there is a concern that the clothes are burned or underheated.

An object of the present disclosure is to provide an iron capable of appropriately transmitting heat to clothes.

An iron according to the present disclosure includes a light emitter that emits light, a base surface that transmits the light, a detector that detects a temperature of the base surface, and a controller that controls an output of the light emitter in accordance with the temperature of the base surface detected by the detector.

According to the iron related to the present disclosure, heat can be appropriately transmitted to clothes.

### BRIEF DESCRIPTION OF THE DRAWINGS

FIG. 1 is a side view of an iron according to a first exemplary embodiment.

FIG. 2 is a sectional view of the iron of FIG. 1.

FIG. 3 is a block diagram illustrating an electrical connection of the iron of FIG. 1.

FIG. 4 is a sectional view of an iron according to a comparative example.

FIG. 5 is a graph representing a temporal change in a fabric temperature when ironing is performed by using the iron according to the comparative example.

FIG. 6 is a graph representing a temporal change in a fabric temperature when ironing is performed by using the iron according to the first exemplary embodiment.

FIG. 7 is a flowchart illustrating an example of first control executed by a controller of an iron according to a second exemplary embodiment.

FIG. 8 is a graph representing a temporal change in a fabric temperature when the iron is kept still and ironing is performed by using the iron according to the second exemplary embodiment.

FIG. 9 is a graph representing a temporal change in a fabric temperature when the iron is moved and ironing is performed by using the iron according to the second exemplary embodiment.

FIG. 10 is a graph of optical characteristics of a filter disposed between a light emitter and a base surface according to the second exemplary embodiment.

FIG. 11A is a perspective view of a reflection plate of the iron in FIG. 1.

FIG. 11B is a sectional view of a reflection plate of the iron in FIG. 1.

FIG. 12A is a diagram illustrating the light emitter of the iron in FIG. 1.

FIG. 12B is a diagram illustrating another example of the light emitter of the iron in FIG. 1.

FIG. 12C is a diagram illustrating another example of the light emitter of the iron in FIG. 1.

### DESCRIPTION OF EMBODIMENT

(One example of practicable mode of iron)

An iron according to one aspect of the present disclosure includes a light emitter that emits light, a base surface that transmits the light, a detector that detects a temperature of the base surface, and a controller that controls an output of the light emitter in accordance with the temperature of the base surface detected by the detector.

Variations in the temperature of the base surface are less than a temperature of clothes. According to the iron, since the output of the light emitter can be controlled in accordance with the temperature of the base surface, heat can be suitably transmitted to the clothes.

According to an example of the iron, a filter that suppresses transmission of visible light between the light emitter and the base surface is provided.

According to the iron, the transmission of the visible light through the base surface is suppressed. Thus, the temperature on the clothes can be kept constant regardless of the color of the clothes. Exposure to ultraviolet rays and glare on the human body can also be alleviated.

According to an example of the iron, the filter reflects the visible light.

According to the iron, since the visible light is reflected, the base surface is not heated. Thus, the temperature of the base surface can be kept constant.

According to an example of the iron, the filter is a dichroic mirror.

According to the iron, the transmission of the ultraviolet rays and visible light through the base surface is suppressed. Thus, the temperature on the clothes can be kept constant regardless of the color of the clothes. Exposure to ultraviolet rays and glare on the human body can also be alleviated.

According to an example of the iron, the iron further includes a reflection plate that reflects the light toward the base surface. The reflection plate has a bowl shape, and has a flat apex.

According to the iron, the light of the light emitter can be more suitably output. The fabric and heat-resistant glass of the base surface can be irradiated with the light from the light emitter with uniform intensity, and wrinkle smoothing ability can be improved. A temperature distribution of the heat-resistant glass can be reduced, and breakage can be prevented.

According to an example of the iron, the light emitter is a halogen lamp or a carbon heater.

According to the iron, a light emitter having a simple configuration and a suitable output can be disposed.

In order to efficiently irradiate the fabric with light, heat-resistant glass having a high infrared transmittance is required. Quartz glass, sapphire glass, or the like is optimal as the heat-resistant glass having a high infrared transmittance. However, the heat-resistant glass is expensive and cannot be used for the iron. Thus, an inexpensive heat-resistant glass having a high infrared transmittance of near to intermediate infrared rays is used, and a halogen lamp or a carbon heater having the same emission wavelength as an emission wavelength of the heat-resistant glass is used as the light emitter. Accordingly, the fabric can be efficiently irradiated with the light, and the wrinkle smoothing ability can be exhibited. The cost is suppressed, and the iron can be adopted.

According to an example of the iron, the light emitter has a U-shape, a horseshoe shape, or a round shape.

According to the iron, an effective light emission region with respect to the base surface is increased, and the infrared rays can be emitted to a distal end of the base surface with uniform intensity. Accordingly, ironing using the distal end of the iron can be performed.

According to an example of the iron, a seal of the light emitter is positioned outside the reflection plate.

According to the iron, variations in irradiation strength to target fabric and the heat-resistant glass are further reduced, wrinkle straightening property can be improved, and breakage of the heat-resistant glass can be prevented. An increase in a temperature of the seal can be prevented, and a lifespan of the light emitter can be prolonged.

According to an example of the iron, the base surface includes a glass body and metal frames. As an example, the glass body is made of heat-resistant glass.

According to an example of the iron, an infrared transmittance of the glass body has a wavelength from 2600 nm to 3500 nm inclusive, and is less than or equal to 50%.

According to the iron, infrared rays in an infrared absorption wavelength range of water are absorbed by the heat-resistant glass, and cut infrared rays are used to increase the temperature of the fabric. Thus, the influence on the temperature increasing property due to the variations in a moisture amount contained in the fabric can be eliminated. Accordingly, wrinkle smoothing performance can be stabilized.

According to an example of the iron, the glass body has a curved shape.

According to the iron, the base surface has a curved shape, and the fabric is smoothly guided when the iron moves. Pressure can be increased or decreased with respect to the fabric, and thus, a stiffening effect is generated. Accordingly, wrinkle smoothing is improved.

According to an example of the iron, an end of the glass body is sandwiched between the metal frames.

According to the iron, when the iron is pressed, a force of the hand is suitably transmitted to the glass body which is a contact surface, and the wrinkle smoothing can be improved. Glass breakage in the case of collision with an obstacle is prevented.

According to an example of the iron, a thermal conductive heat-resistant bond, a paint, or grease is applied to an interface surface between the glass body and the metal frame.

According to the iron, it is possible to prevent the temperature of the metal frame having a low emissivity from becoming lower than an emissivity of the heat-resistant glass.

Accordingly, the wrinkle smoothing performance in ironing using the distal end of the iron can be improved.

According to an example of the iron, the controller performs control at predetermined intervals to increase the output of the light source when the temperature detected by the detector is within a first predetermined temperature, and to decrease or stop the output of the light source when the temperature of the base surface is greater than or equal to a second predetermined temperature higher than the first predetermined temperature. Here, as an example, the second predetermined temperature is a temperature at which the fabric is not damaged, and the first predetermined temperature is a low temperature within 10° C. from the second predetermined temperature.

According to the iron, damage to the fabric can be prevented, a cut state of the light source can be immediately returned to an entering state, and the wrinkle smoothing performance can be maintained.

According to an example of the iron, the detector includes a thermistor, a resistance temperature detector, or a thermocouple, the detector is disposed between the light emitter and the base surface, and the detector is closely fixed to the base surface within a predetermined range from a center portion of the base surface. Here, as an example within the predetermined range, the predetermined range is within Φ50 mm from the center portion of the base surface.

According to the iron, optimum measurement can be performed in real time by one sensor without considering the variations in the temperature distribution of the base surface when the base surface is moved in an indefinite direction and at an indefinite speed on the fabric of which the temperature is not constant. Accordingly, the wrinkle smoothing performance can be stabilized.

According to an example of the iron, the detector and the lead wire connected to the detector are covered with the infrared reflection member.

According to the iron, it is possible to prevent self-heating due to the infrared rays by reflecting the infrared rays emitted to the sensor. Accordingly, the measurement can be performed accurately, and the wrinkle smoothing performance can be stabilized.

The infrared reflection member is a tape, a sheet, or a case made of aluminum, copper, brass, silver, gold, platinum, nickel, chromium, lead, or tin.

According to the iron, it is possible to prevent self-heating due to the infrared rays by reflecting the infrared rays emitted to the sensor. Accordingly, the measurement can be performed accurately, and the wrinkle smoothing performance can be stabilized.

### First Exemplary Embodiment

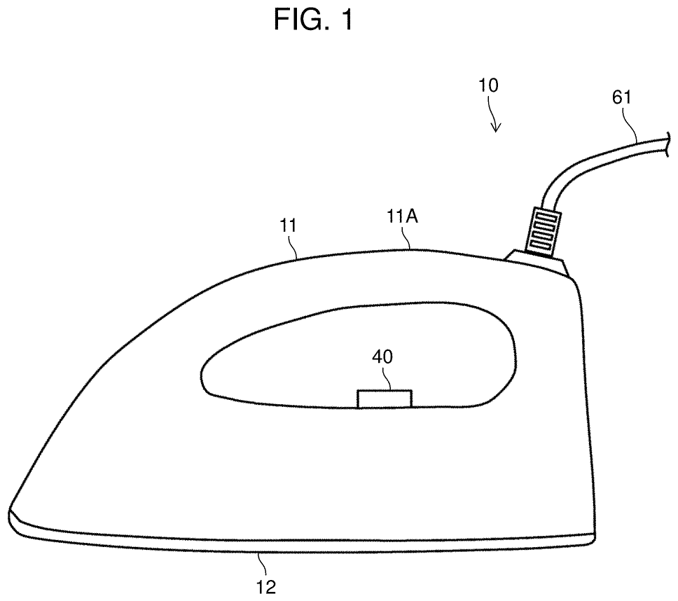

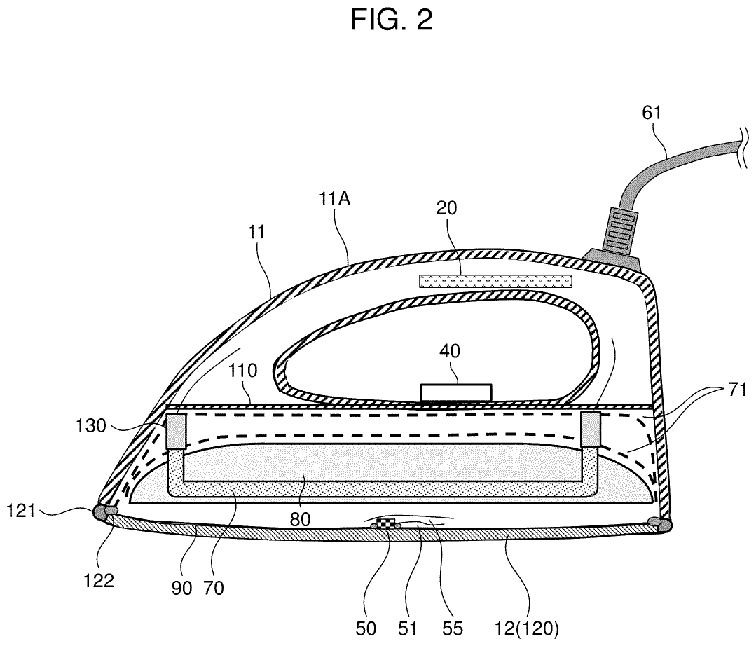

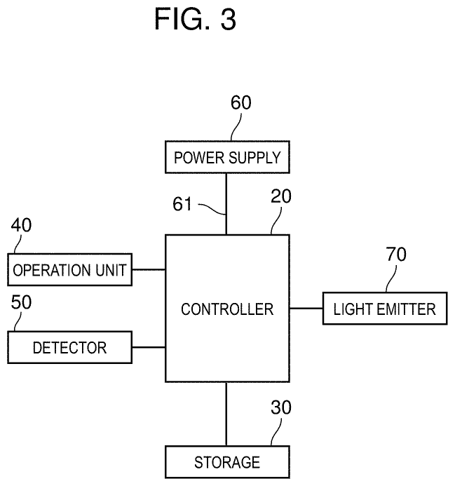

Hereinafter, iron 10 according to a first exemplary embodiment will be described with reference to FIGS. 1 to 3. Iron 10 has an iron function of smoothing wrinkles of clothes. The iron function is a function of smoothing wrinkles of clothes by applying heat and pressure of iron 10 to the wrinkles of the clothes. Main elements constituting iron 10 are housing 11 and base surface 12. Housing 11 constitutes an appearance of iron 10 and houses at least one of the other elements constituting iron 10. Although housing 11 has any shape, it is preferable that grip 11A configured to be easily held by a user is formed. Housing 11 is made of any material having excellent heat resistance. In one example, the material of housing 11 is polycarbonate. Housing 11 may include a transparent portion (not illustrated) made of a transparent material partially or entirely such that the state of clothes during ironing can be visually recognized. An inside of housing 11 is partitioned by partition plate 110. Housing 11 includes an opening that opens an inner space. Base surface 12 is provided so as to substantially coincide with a shape of the opening of housing 11. Base surface 12 transmits heat and pressure to the clothes. Base surface 12 is made of a material having excellent infrared transparency, heat resistance, and thermal conductivity. In one example, base surface 12 includes glass body 120 made of heat-resistant glass and metal frames 121. An end of glass body 120 is sandwiched between metal frames 121. In order to improve thermal conductivity between glass body 120 and metal frames 121, a thermal conductive heat-resistant bond is applied to a contact surface between glass body 120 and metal frames 121. Instead of the bond, paint or grease may be used. Glass body 120 uses heat-resistant glass having a high transmittance of near to intermediate infrared rays and a transmittance of 50% or less of infrared rays having a wavelength from 2600 nm to 3500 nm inclusive. For example, inexpensive heat-resistant glass such as SCHOTT TEMPAX glass can be used. It is preferable that tempered glass is used in consideration of safety of glass breakage due to dropping or the like. It is preferable that a shape of glass body 120 is a curved shape in consideration of wrinkle smoothing. However, the present disclosure is not limited thereto, and glass body 120 may be a flat plate.

Iron 10 further includes controller 20, storage 30, operation unit 40, detector 50, power supply 60, and light emitter 70. At least one of controller 20, storage 30, operation unit 40, detector 50, power supply 60, and light emitter 70 is held inside housing 11. Controller 20 includes an arithmetic processing unit that executes a control program. The arithmetic processing unit includes, for example, at least one or both of a central processing unit (CPU) and a micro processing unit (MPU). Controller 20 is configured to communicate with storage 30, operation unit 40, detector 50, and light emitter 70 in a wireless or wired manner Controller 20 starts control when, for example, electric power is supplied from power supply 60 and an operation signal is input from operation unit 40. Preferably, controller 20 is provided in housing 11 at a position away from light emitter 70 that is a heat generation source. In one example, controller 20 is provided at a place corresponding to grip 11A.

Storage 30 stores program information and control information for executing various controls executed by controller 20. Storage 30 includes, for example, a non-volatile memory and a volatile memory. The control information includes information in which a type of clothes is associated with an output amount of light emitter 70, and information in which a temperature of base surface 12 is associated with a temperature of the fabric of the clothes. The type of the clothes is, for example, a material of the clothes. One example of the material of the clothes is polyester, nylon, and cotton. Storage 30 is provided in the same control circuit as, for example, controller 20.

Operation unit 40 outputs an operation signal by an operation by the user to controller 20, for example. The operation signal includes, for example, a signal related to adjustment of a light emission amount of light emitter 70 and a signal related to selection of the type of the clothes or a washing display symbol of New JIS (ISO 3758). A part of operation unit 40 is configured to protrude toward an outside of housing 11 to allow the user to operate easily. Operation unit 40 is constituted by, for example, a button, a switch, and a dial. Operation unit 40 may be constituted by a touch panel.

Detector 50 detects various kinds of information about iron 10. Detector 50 detects, for example, temperature information. Detector 50 includes a thermistor. The present disclosure is not limited thereto, and a resistance thermometer or a thermocouple may be used for detector 50. In order to prevent the thermistor from being irradiated with infrared rays and self-heating, the thermistor and lead wire 51 connected to the thermistor are covered with infrared reflection member 55 (as an example, an aluminum tape) having a relatively high emissivity. Accordingly, the measurement accuracy of the thermistor is improved. In addition, thermally conductive grease is applied between the thermistor and the base surface.

An example of the temperature information detected by detector 50 is the temperature of base surface 12. The temperature information is output, as an electric signal, to controller 20. A position where detector 50 is provided is, for example, the inside of housing 11 on base surface 12. Preferably, a center of detector 50 coincides with a center of light emitter 70 in a vertical direction of iron 10. Detector 50 may be configured to detect the number of times of use and a use time of iron 10.

Power supply 60 supplies electric power to controller 20, storage 30, operation unit 40, detector 50, and light emitter 70. In the illustrated example, power supply 60 is an external power supply such as a commercial power supply. Power supply 60 may have a configuration of a secondary battery provided inside housing 11. When power supply 60 is the external power supply, iron 10 and power supply 60 are connected by power line 61.

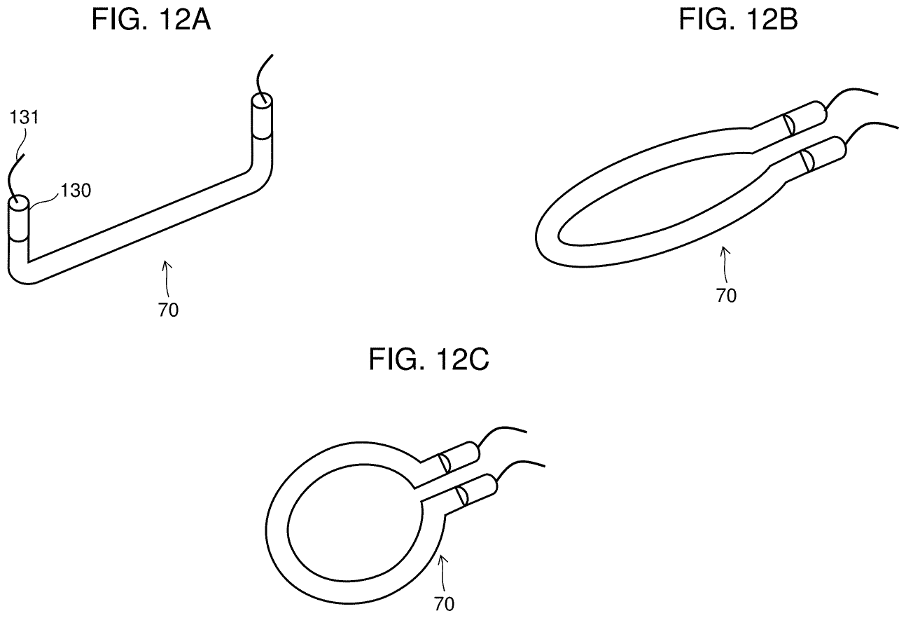

Light emitter 70 generates light to transmit heat to the clothes. Light emitter 70 is constituted by a halogen lamp or a carbon heater that generates heat by electricity. A shape of light emitter 70 is any shape. In one example, the shape of light emitter 70 is a U-shape as illustrated in FIG. 12A. Light emitter 70 includes lead wire 131 connected to light emitter 70 and seal 130 through which lead wire 131 is inserted. As illustrated in FIGS. 12B and 12C, the shape of light emitter 70 may be a shape having a wide light emitting area, such as a horseshoe shape or a round shape, in addition to the U-shape. Accordingly, an effective light emission region for base surface 12 increases, and the infrared rays can be emitted to a distal end of base surface 12 with uniform intensity. Therefore, ironing using the distal end of the iron can be performed.

The number of turns and a cross-sectional area of a filament of light emitter 70 are adjusted to set variations in radiation intensity within 20% in the entire light emitting unit. Accordingly, the entire target fabric can be irradiated with the infrared rays with uniform intensity, and the wrinkle smoothing can be improved. It is also possible to prevent breakage due to a temperature distribution of the heat-resistant glass. Controller 20 controls the light emission amount of light emitter 70 by controlling a power supply amount from power supply 60. Preferably, heat insulating member 71 is provided between light emitter 70 and controller 20. Heat insulating member 71 is made of, for example, glass wool, rock wool, urethane, or polystyrene.

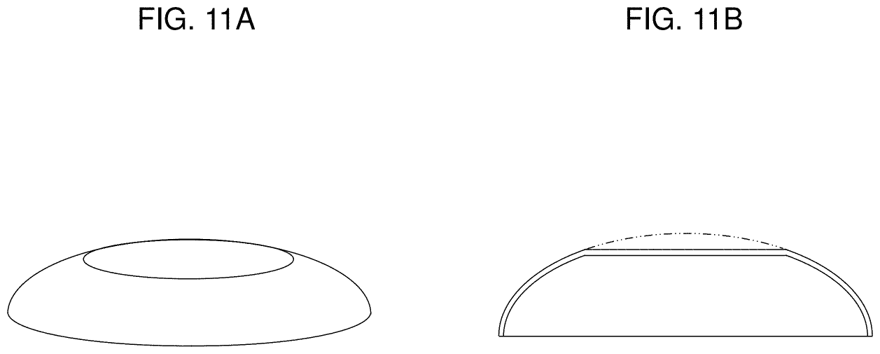

Iron 10 further includes reflection plate 80 and filter 90. Reflection plate 80 and filter 90 are provided in housing 11. Reflection plate 80 is configured to efficiently transmit light and heat of light emitter 70 to base surface 12. Reflection plate 80 is preferably configured to reflect light and heat of light emitter 70 with respect to entire base surface 12. For example, as illustrated in FIGS. 11A and 11B, a shape of reflection plate 80 is a bowl shape in which light emitter 70 is provided at the center, and is a shape having a flat apex. A surface of reflection plate 80 is made of stainless steel or aluminum metal, for example. Seal 130 which is not a light emitting region of light emitter 70 is positioned outside reflection plate 80.

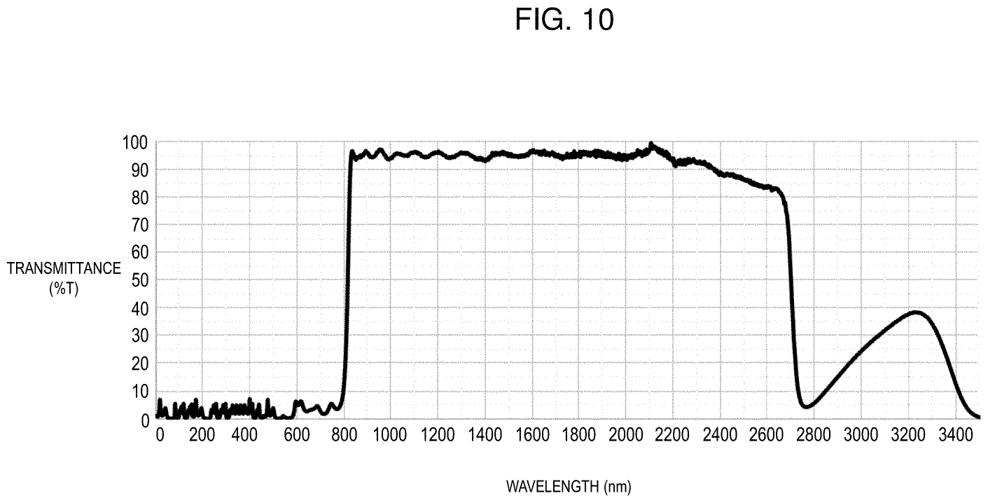

Filter 90 is configured to suppress transmission of light having a predetermined wavelength output from light emitter 70 through base surface 12. An example of the predetermined light is visible light. Preferably, filter 90 is configured to reflect visible light such that the visible light is not output from base surface 12 or an output amount is decreased. A shape of filter 90 is configured to substantially coincide with the shape of base surface 12. Filter 90 is configured to come into contact with light emitter 70 side of base surface 12. Filter 90 includes, for example, a dichroic mirror on which a dielectric multilayer film is deposited. Filter 90 may be configured to suppress transmission of ultraviolet rays through base surface 12. FIG. 10 is a graph of transmittance of the dichroic mirror according to the present exemplary embodiment.

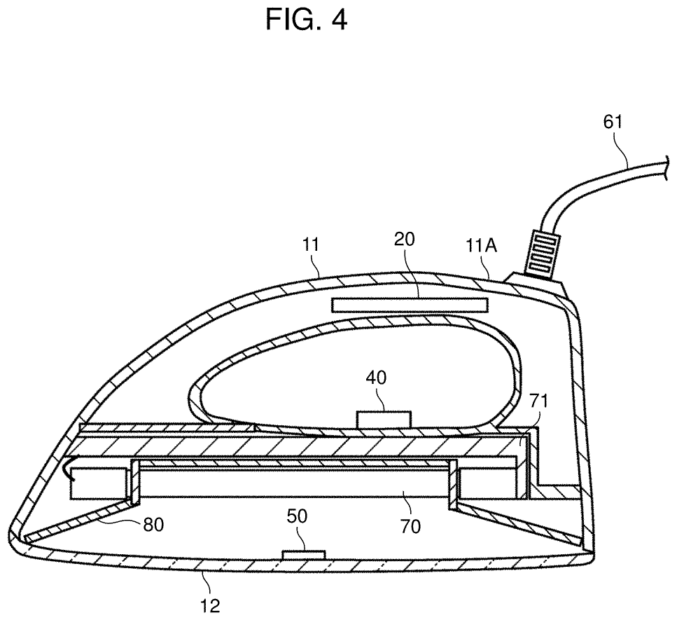

FIG. 4 illustrates a configuration of iron 10 according to a comparative example. Iron 10 according to the comparative example has the same configuration as iron 10 according to the first exemplary embodiment except that filter 90 is not provided. In iron 10 according to the comparative example, light transmitted through base surface 12 includes visible light and ultraviolet rays.

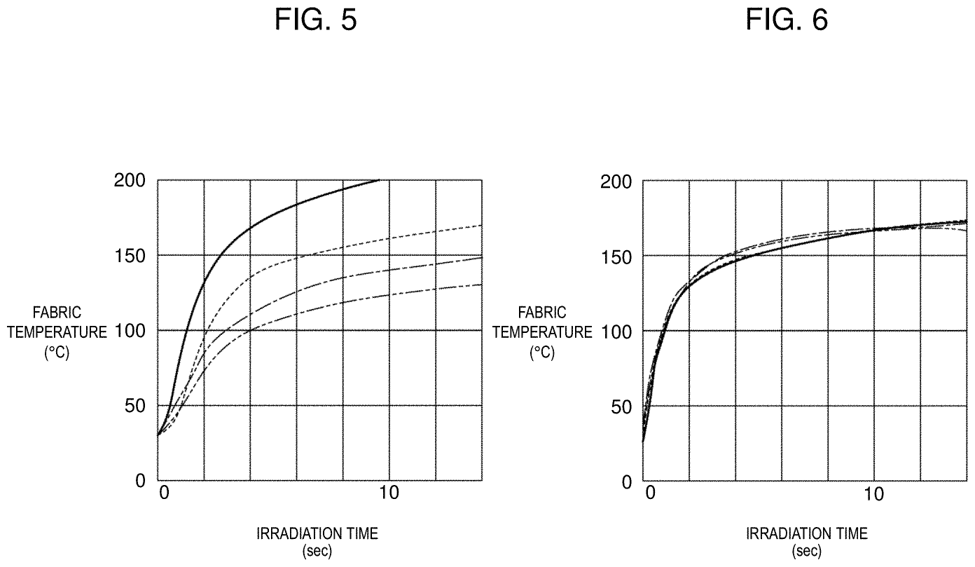

An increase in the temperature of the fabric when iron 10 according to the first exemplary embodiment or iron 10 according to the comparative example is used will be described with reference to FIGS. 5 and 6. A temporal change in the temperature of the fabric is measured by a separately prepared thermographic camera and a thermocouple. Iron 10 includes a halogen lamp as light emitter 70. An examiner selects cotton fabric as the type of the clothes by operating operation unit 40, and controller 20 controls light emitter 70 in accordance with the cotton fabric.

Solid lines in FIGS. 5 and 6 illustrate results for black clothes made of cotton fabric. Broken lines in FIGS. 5 and 6 illustrate results for blue clothes made of cotton fabric. Dashed dotted lines in FIGS. 5 and 6 illustrate results for red clothes made of cotton fabric. Dashed double-dotted lines in FIGS. 5 and 6 illustrate results for white clothes made of cotton fabric.

As illustrated in FIG. 5, in iron 10 according to the comparative example, the variations in the temperature of the fabric increased as an irradiation time elapsed. On the other hand, as illustrated in FIG. 6, in iron 10 according to the first exemplary embodiment, the temperature of the fabric was kept constant regardless of the color of the clothes. In iron 10 according to the first exemplary embodiment, the temperature of the fabric converged within a range from 150° C. to 170° C. inclusive suitable for exhibiting the iron function.

A function of iron 10 according to the first exemplary embodiment will be described.

The user operates operation unit 40 to start supply electric power from power supply 60. The user operates operation unit 40 to select the type of the fabric of the clothes to be ironed or the washing display symbol of New JIS (ISO 3758). Controller 20 determines the output amount of light emitter 70 based on the information in which the type of the clothes stored in storage 30 is associated with the output amount of light emitter 70. Most of the light output from light emitter 70 is directed to base surface 12, and a part thereof is reflected by reflection plate 80 and directed to base surface 12. The visible light is reflected by filter 90 provided on light emitter 70 side of base surface 12. On the other hand, the infrared rays pass through filter 90 and are output from base surface 12. The clothes are heated by the infrared rays, and the user removes the wrinkles of the clothes by pressing base surface 12 of iron 10 while visually recognizing the state of the clothes from the transparent portion of housing 11.

According to iron 10 according to the first exemplary embodiment, the following effects can be obtained.

The infrared rays output from light emitter 70 can keep the fabric temperature constant regardless of the color of the clothes. Thus, variations in heating are less likely to occur, and the clothes are hardly burned or underheated.

### Second Exemplary Embodiment

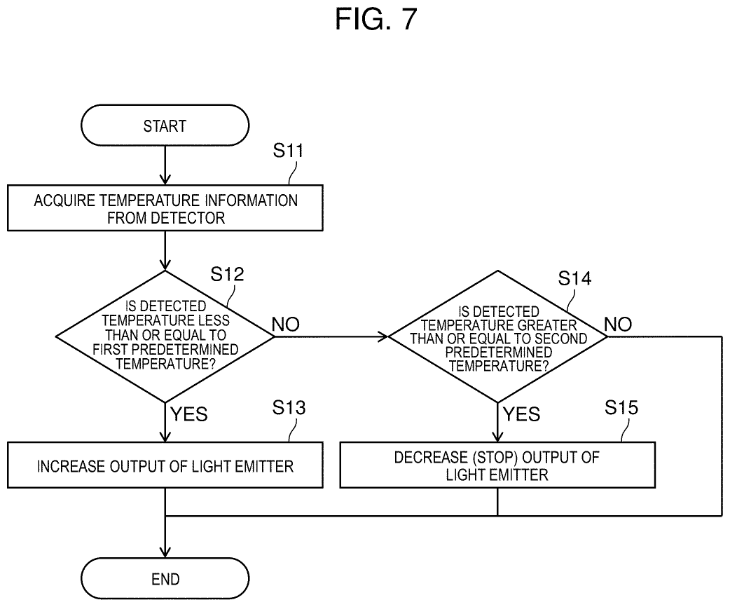

Iron 10 according to a second exemplary embodiment will be described with reference to FIGS. 7, 8, and 9. Iron 10 according to the second exemplary embodiment is similar to iron 10 according to the first exemplary embodiment except that controller 20 executes first control for controlling the output of light emitter 70 based on the temperature detected by detector 50. Thus, the description of the same configuration will be omitted in part or whole.

Controller 20 executes the first control based on the temperature information detected from detector 50. The temperature information is, for example, the temperature of base surface 12. More specifically, the temperature information is the temperature of glass body 120. Controller 20 estimates the temperature of the fabric as the detected temperature from, for example, information stored in storage 30 and indicating a correspondence between the temperature of base surface 12 and the temperature for each type of fabric. Controller 20 increases the output of light emitter 70 when the detected temperature is less than or equal to a first predetermined temperature. When the temperature is greater than or equal to a second predetermined temperature higher than the first predetermined temperature, the output of light emitter 70 is decreased. In one example, in the case of cotton fabric, the first predetermined temperature is 190° C. and the second predetermined temperature is 200° C. A difference between the first predetermined temperature and the second predetermined temperature was set to 10° C.

An example of control executed by controller 20 will be described with reference to FIG. 7.

Controller 20 determines the output of light emitter 70 from a table of the type of the fabric of the clothes selected by the user and the fabric temperature. The table is stored in storage 30 in advance. In step S11, controller 20 acquires the temperature information from detector 50. Controller 20 refers to storage 30 to estimate the detected temperature that is the temperature of the fabric of the clothes. In step S12, controller 20 determines whether the detected temperature is less than or equal to the first predetermined temperature. When it is determined that the detected temperature is less than or equal to the first predetermined temperature, controller 20 executes the processing of step S13. In step S13, controller 20 increases the output of light emitter 70. Controller 20 ends the processing. When it is determined that the detected temperature is not less than or equal to the first predetermined temperature, controller 20 executes the processing of step S14. In step S14, controller 20 determines whether the detected temperature is greater than or equal to the second predetermined temperature. When it is determined that the detected temperature is greater than or equal to the second predetermined temperature, controller 20 executes the processing of step S15. In step S15, controller 20 decreases or stops the output of light emitter 70. Controller 20 ends the processing. When it is determined that the detected temperature is not greater than or equal to the second predetermined temperature, controller 20 ends the processing. Controller 20 executes this control (also referred to as first control) at predetermined intervals while electric power is supplied from power supply 60.

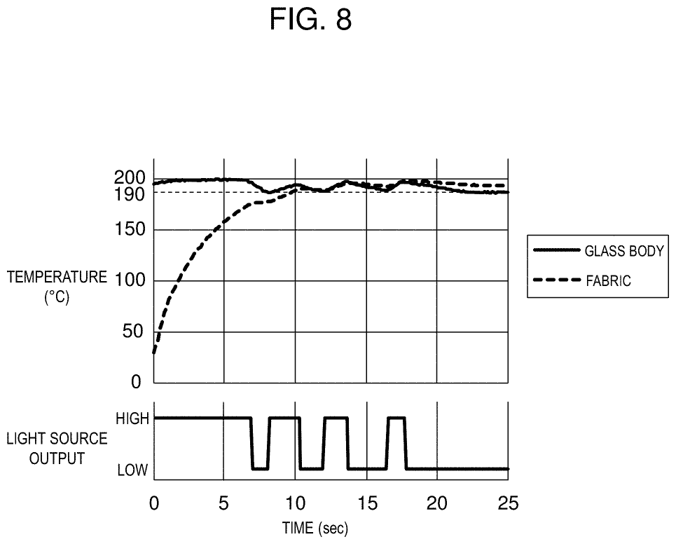

FIG. 8 illustrates the fabric temperature when the output of light emitter 70 is increased or decreased by performing the control using the temperature information of base surface 12 (more specifically, glass body 120) from detector 50. A solid line indicates the temperature of glass body 120, and a broken line indicates the temperature of the fabric. As a condition, a white cotton fabric having a thickness of 0.15 mm is used, the first predetermined temperature is 190° C., and the second predetermined temperature is 200° C. After iron 10 is brought into contact with the fabric, the time has elapsed in a stationary state without moving. The output of light emitter 70 is decreased when the temperature information of detector 50 is greater than or equal to 200° C. which is the second predetermined temperature, and the output of light emitter 70 is increased when the temperature information is less than or equal to 190° C. which is the first predetermined temperature. The increase in the fabric temperature is suppressed even when the irradiation time becomes long by executing this control.

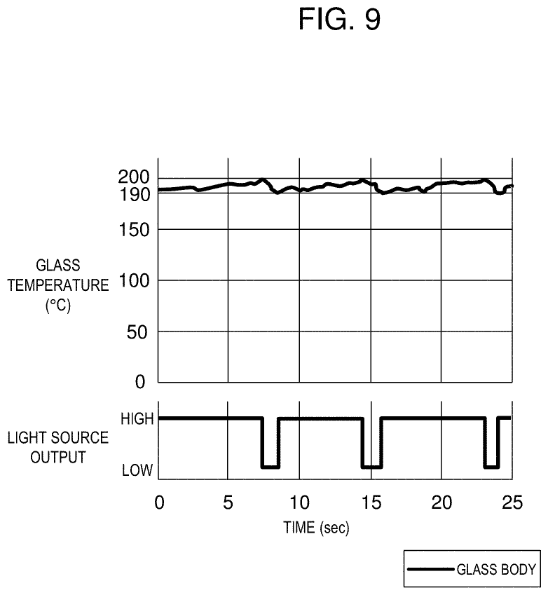

FIG. 9 illustrates the temperature of glass body 120 when the output of light emitter 70 is increased or decreased in a case where iron 10 is moved at a speed of 10 cm/sec. The conditions other than the movement of iron 10 are the same as the conditions in the case illustrated in FIG. 8. Since the fabric is not at a fixed position with respect to the iron when the fabric moves, the fabric temperature is not displayed on the graph. When the temperature is greater than or equal to 200° C. which is the second predetermined temperature by the control, the output of light emitter 70 is decreased. Thereafter, since the temperature of the glass body is immediately cooled by the fabric with the movement of iron 10, the temperature information of detector 50 is less than or equal to the first predetermined temperature. Accordingly, the output of light emitter 70 is prevented from being decreased for a long time due to the increase in the output of light emitter 70. Therefore, wrinkle smoothing ability is stably maintained.

A function of iron 10 according to the second exemplary embodiment will now be described.

The user operates operation unit 40 to start supply electric power from power supply 60. The user operates operation unit 40 to select the type of the fabric of the target clothes or the washing display symbol of New JIS (ISO 3758). Controller 20 determines the output of light emitter 70 from the stored table of the type of the fabric of the clothes and the fabric temperature. Most of the light output from light emitter 70 is directed to base surface 12, and a part thereof is reflected by reflection plate 80 and directed to base surface 12. The visible light is reflected by filter 90 provided on light emitter 70 side of base surface 12. On the other hand, the infrared rays pass through filter 90 and are output from base surface 12. The infrared rays heat the clothes to remove the wrinkles. As the wrinkles are removed, base surface 12 is heated. Detector 50 detects the temperature information, and controller 20 decreases or increases the output of light emitter 70 based on the temperature information.

According to iron 10 according to the second exemplary embodiment, the following effect can be obtained.

When the detected temperature is greater than or equal to the predetermined temperature, since the output of light emitter 70 is decreased, the clothes are hardly burned. Since the fabric temperature is estimated from the temperature of base surface 12 having small variations instead of detecting the clothes temperature having large variations, since it is not necessary to newly provide a sensor for measuring the temperature of the fabric, the configuration of iron 10 can be simplified.

In the above-described exemplary embodiment, the thermistor is used for detector 50 in consideration of the accuracy and real-time property of detector 50. Detector 50 is disposed between light emitter 70 and glass body 120. Detector 50 sandwiches the thermally conductive grease within a predetermined range from a center portion of glass body 120 (for example, within Φ50 mm from the center portion of glass body 120) to be closely fixed to glass body 120. The thermistor and lead wire 51 are covered with infrared reflection member 55 (as an example, an aluminum tape). The infrared rays are reflected by infrared reflection member 55 such that the infrared rays do not directly hit detector 50. That is, detector 50 and the lead wire connected to detector 50 are covered with infrared reflection member 55. Infrared reflection member 55 is a tape, a sheet, or a case made of a material having relatively low emissivity. Here, the material having a relatively low emissivity is, for example, aluminum, copper, brass, silver, gold, platinum, nickel, chromium, lead, tin, or the like. A bimetal which is a mechanical temperature sensor may be attached to a glass surface between light emitter 70 and base surface 12 in order to prevent fabric damage, combustion, and burns due to an abnormally high temperature state caused by failure or malfunction of detector 40 or controller 20. Accordingly, it is possible to appropriately shut off the power supply.

(Modifications)

The exemplary embodiments exemplarily describe the iron in a practicable mode of the present disclosure, and does not intend to limit the mode. The present disclosure can assume, in addition to the exemplary embodiments, following modifications of the exemplary embodiments, and any mode acquired by combining at least two modifications which do not contradict with each other, for example.

Iron 10 may further include a notification unit that notifies information currently detected by detector 50. The notification unit notifies the user of, for example, the temperature information of the fabric estimated from the current temperature of base surface 12 and the current temperature of base surface 12. When power supply 60 of iron 10 is the secondary battery, a current remaining battery level of the secondary battery may be notified.

In the first control, controller 20 may perform control of increasing the output of light emitter 70 when the detected temperature is lower than the predetermined temperature by a threshold value or more. The threshold value is, for example, 20° C.

The iron according to the present disclosure is applicable to an iron for removing wrinkles of clothes for business use and household use.

### REFERENCE MARKS IN THE DRAWINGS

10 iron

12 base surface

20 controller

55 Infrared reflection member

70 light emitter

80 reflection plate

90 filter

120 glass body

121 metal frame

122 heat conductive member

130 seal

1. An iron comprising:
a light emitter that emits light;
a base surface that transmits the light;
a detector that detects a temperature of the base surface; and
a controller that controls an output of the light emitter in accordance with the temperature of the base surface detected by the detector; and
a mechanical temperature sensor that shuts off a power supply when the base surface is in an abnormally high temperature state caused by failure or malfunction of the detector or the controller.

2. The iron according to claim 1, further comprising a filter that is disposed between the light emitter and the base surface and suppresses transmission of visible light.

3. The iron according to claim 2, wherein the filter reflects the visible light.

4. The iron according to claim 2, wherein the filter is a dichroic mirror.

5. The iron according to claim 1, further comprising a reflection plate that reflects the light toward the base surface,
wherein the reflection plate has a bowl shape, and has a flat apex.

6. The iron according to claim 1, wherein the light emitter is a halogen lamp or a carbon heater.

7. The iron according to claim 1, wherein the light emitter has a U-shape, a horseshoe shape, or a round shape.

8. The iron according to claim 1, wherein the light emitter includes a seal positioned outside the reflection plate.

9. The iron according to claim 1, wherein the base surface includes a glass body and metal frames.

10. The iron according to claim 9, wherein an infrared transmittance of the glass body has a wavelength from 2600 nm to 3500 nm inclusive, and is less than or equal to 50%.

11. The iron according to claim 9, wherein the glass body is heat-resistant tempered glass has a curved shape.

12. The iron according to claim 9, wherein an end of the glass body is sandwiched between the metal frames.

13. The iron according to claim 9, wherein a thermal conductive heat-resistant bond, a paint, or grease is applied to an interface surface between the glass body and each of the metal frames.

14. The iron according to claim 1, wherein the controller executes control for increasing an output of the light emitter when the temperature detected by the detector is within a first predetermined temperature, and decreasing or stopping the output of the light emitter when the temperature of the base surface is greater than or equal to a second predetermined temperature higher than the first predetermined temperature at a predetermined interval.

15. The iron according to claim 1, wherein
the detector includes a thermistor, a resistance temperature detector, or a thermocouple,
the detector is disposed between the light emitter and the base surface, and
the detector is closely fixed to the base surface within a predetermined range from a center portion of the base surface.

16. The iron according to claim 15, wherein the detector and a lead wire connected to the detector are covered with an infrared reflection member.

17. The iron according to claim 16, wherein the infrared reflection member is a tape, a sheet, or a case made of aluminum, copper, brass, silver, gold, platinum, nickel, chromium, lead, or tin.
